(19) United States
(12) Patent Application Publication
(10) Pub. No.: US 2023/0376858 A1
(43) Pub. Date: Nov. 23, 2023

(54) CLASSIFICATION-BASED MACHINE LEARNING FRAMEWORKS TRAINED USING PARTITIONED TRAINING SETS

(71) Applicant: UnitedHealth Group Incorporated, Minnetonka, MN (US)

(72) Inventors: Eric B. Tal, Northbrook, IL (US); Joel D. Stremmel, Iowa City, IA (US); Vijay S. Nori, Roswell, GA (US); Daniel J. Mulcahy, Evanston, IL (US); Mostafa Bayomi, Dublin (IE); Ahmed Kayal, Brooklyn, NY (US)

(21) Appl. No.: 17/663,893

(22) Filed: May 18, 2022

(51) Int. Cl. G06N 20/20; G06K 9/62

(52) U.S. Cl. CPC G06N 20/20; G06K 9/6227; G06K 9/626

(57) ABSTRACT

Various embodiments of the present invention improve the speed of training classification-based machine learning models by introducing techniques that enable efficient parallelization of such training routines while enhancing the accuracy of each parallel implementation of a training routine. For example, in some embodiments, a classification-based machine learning model is trained via executing N parallel processes each executing a portion of a training routine, where each parallel process is performed using a training set having a uniform distribution of labels associated with the classification-based machine learning model. In this way, each parallel process is more likely to update parameters of the classification-based machine learning model in accordance with a holistic representation of the training data, which in turn improves the overall accuracy of the resulting trained classification-based machine learning models while enabling parallel training of the classification-based machine learning model.

### BACKGROUND

Various embodiments of the present invention address technical challenges related to performing predictive data analysis operations that require training a plurality of classification-based machine learning models and disclose various innovative techniques for improving efficiency of data processing and data storage operations for predictive data analysis systems.

### BRIEF SUMMARY

In general, embodiments of the present invention provide methods, apparatuses, systems, computing devices, computing entities, and/or the like for performing predictive data analysis operations that require training a plurality of classification-based machine learning models.

In accordance with one aspect, a method for generating a classification output for a classification input using a plurality of classification-based machine learning models is provided. In one embodiment, the computer-implemented method comprises: generating, by one or more processors, using the plurality of classification-based machine learning models, and based at least in part on the classification input, the classification output, wherein: (i) the plurality of classification-based machine learning models is trained based at least in part on N training data partitions, (ii) training the plurality of classification-based machine learning models comprises partitioning a group of training samples into the N training data partitions and loading each training data partition on a memory storage medium as a unit, (iii) each training data partition is generated based at least in part on a partitioned subset of the group of training samples that is generated in a manner that is configured to ensure that the partitioned subset comprises a uniform distribution of a plurality of partitioned training samples across a plurality of classes associated with the plurality of classification-based machine learning models, and (iv) N is determined based at least in part on a minimal number of allowed partitions for the plurality of classification-based machine learning models, a maximal number of allowed partitions for the plurality of classification-based machine learning models, and a maximum allowed number of training samples in a particular training data partition; and performing one or more prediction-based actions based at least in part on the classification output.

In accordance with another aspect, an apparatus comprising at least one processor and at least one memory, including computer program code, is provided. In one embodiment, the at least one memory and the computer program code may be configured to, with the processor, cause the apparatus to generate a classification output for a classification input using a plurality of classification-based machine learning models. In one embodiment, the computer program code is configured to, with the at least one processor, cause the apparatus to: generate, using the plurality of classification-based machine learning models, and based at least in part on the classification input, the classification output, wherein: (i) the plurality of classification-based machine learning models is trained based at least in part on N training data partitions, (ii) training the plurality of classification-based machine learning models comprises partitioning a group of training samples into the N training data partitions and loading each training data partition on a memory storage medium as a unit, (iii) each training data partition is generated based at least in part on a partitioned subset of the group of training samples that is generated in a manner that is configured to ensure that the partitioned subset comprises a uniform distribution of a plurality of partitioned training samples across a plurality of classes associated with the plurality of classification-based machine learning models, and (iv) N is determined based at least in part on a minimal number of allowed partitions for the plurality of classification-based machine learning models, a maximal number of allowed partitions for the plurality of classification-based machine learning models, and a maximum allowed number of training samples in a particular training data partition; and perform one or more prediction-based actions based at least in part on the classification output.

In accordance with yet another aspect, a computer program product is provided. The computer program product may comprise at least one computer-readable storage medium having computer-readable program code portions stored therein, the computer-readable program code portions comprising executable portions configured to generate a classification output for a classification input using a plurality of classification-based machine learning models. In one embodiment, the computer-readable code portions comprising executable portions may be configured to: generate, using the plurality of classification-based machine learning models, and based at least in part on the classification input, the classification output, wherein: (i) the plurality of classification-based machine learning models is trained based at least in part on N training data partitions, (ii) training the plurality of classification-based machine learning models comprises partitioning a group of training samples into the N training data partitions and loading each training data partition on a memory storage medium as a unit, (iii) each training data partition is generated based at least in part on a partitioned subset of the group of training samples that is generated in a manner that is configured to ensure that the partitioned subset comprises a uniform distribution of a plurality of partitioned training samples across a plurality of classes associated with the plurality of classification-based machine learning models, and (iv) N is determined based at least in part on a minimal number of allowed partitions for the plurality of classification-based machine learning models, a maximal number of allowed partitions for the plurality of classification-based machine learning models, and a maximum allowed number of training samples in a particular training data partition; and perform one or more prediction-based actions based at least in part on the classification output.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of a system architecture that can be used to practice embodiments of the present invention;

FIG. 2 provides an example predictive data analysis computing entity in accordance with some embodiments discussed herein;

FIG. 3 provides a flowchart diagram illustrating an example process in accordance with some embodiments discussed herein;

FIG. 4 provides a flowchart diagram illustrating another example process in accordance with some embodiments discussed herein;

FIG. 5 provides an operational example in accordance with some embodiments discussed herein;

FIG. 6 provides another operational example in accordance with some embodiments discussed herein; and

FIG. 7 provides an operational example of a prediction output user interface in accordance with some embodiments discussed herein.

### DETAILED DESCRIPTION

Various embodiments of the present invention are described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. OVERVIEW

Various embodiments of the present invention improve the speed of training classification-based machine learning models by introducing techniques that enable efficient parallelization of such training routines while enhancing the accuracy of each parallel implementation of a training routine. For example, in some embodiments, a classification-based machine learning model is trained via executing N parallel processes each executing a portion of a training routine, where each parallel process is performed using a training set having a uniform distribution of labels associated with the classification-based machine learning model. In this way, each parallel process is more likely to update parameters of the classification-based machine learning model in accordance with a holistic representation of the training data, which in turn improves the overall accuracy of the resulting trained classification-based machine learning models while enabling parallel training of the classification-based machine learning model. Accordingly, various embodiments of the present invention make important technical contributions via improving the speed of training classification-based machine learning models and by introducing techniques that enable efficient parallelization of such training routines while enhancing the accuracy of each parallel implementation of a training routine.

Various embodiments of the present invention disclose techniques for performing predictive data analysis operations that improve efficiency and/or reliability of performing such operations. Various embodiments of the present invention reduce the time and memory requirements for training, evaluating, and optimizing a plurality of classification-based machine learning models simultaneously and thus improve data processing/retrieval efficiency in addition to data storage efficiency of various predictive data analysis systems. The inventors have confirmed, via experiments and theoretical calculations, that various embodiments of the disclosed techniques improve efficiency and accuracy of predictive data analysis systems relative to various state-of-the-art solutions.

Machine learning techniques and predictive models (e.g., classification-based machine learning models) may be used in a variety of applications in order to generate predictive outputs. However, in many examples, it may be difficult to select one or more available predictive models for a particular application or task, as each predictive model may perform differently in different contexts. In many examples, the process of creating and testing a single model is time consuming (e.g., lasting several months) when starting with labeled raw data. For example, substantial processing and computing resources may be required to transform data to a form in which it can be processed by a machine learning model. In some examples, optical character recognition (OCR) processing may be applied to text data, unseparated text data may need to be split into pieces corresponding with labels, text may need to be cleaned and/or formatted consistently, and/or the like. Additionally, in some examples, different available vectorization methods for transforming input data may affect model performance. Moreover, due to variability of conditions during testing (e.g., use of different datasets or generic datasets to test machine learning models), it may be difficult or impossible to ascertain which predictive model is optimal for a particular application. Further, merely combining individual functions necessary for an end-to-end model comparison in a serial fashion is computationally inefficient in terms of processing time and intractable in terms of memory requirements. Existing models have not been designed to maximize accuracy and performance for certain data inputs, including medical or healthcare contexts.

Various embodiments of the present invention disclose an end-to-end model comparison system that is configured to receive un-curated, labeled input data, as well as a performance definition set (for example, including selecting the highest precision at a given recall or the highest recall at a given precision). With no further user involvement, the system can automatically deliver a list of models that are rank ordered according to a performance definition set and in which each of the machine learning models has hyperparameters that are optimized to meet or satisfy the performance definition set given time and memory constraints.

Accordingly, by utilizing some or all of the innovative techniques disclosed herein for performing predictive data analysis steps/operations, various embodiments of the present invention increase efficiency and accuracy of data storage operations, data retrieval operations, and/or query processing operations across various data storage systems, such as various data storage systems that are part of client-server data storage architectures. In doing so, various embodiments of the present invention make substantial technical contributions to the field of database systems and substantially improve state-of-the-art data storage systems.

### II. DEFINITIONS OF CERTAIN TERMS

The term “classification input” may refer to a data object or data entity that describes input data/information that can be used to generate and/or train one or more classification-based machine learning models. In various embodiments, a classification input may be or comprise structured or unstructured data, un-curated data, labeled data, a performance definition set, a classification type (e.g., multi-class, multi-label, binary) and/or the like. In some embodiments, a classification input may comprise medical data/information or non-medical data that is capable of being vectorized. In some embodiments, a classification input may comprise medical image data. By way of example, a classification input may include training data samples which may be data objects storing and/or providing access to information/data associated with a patient/individual. An example training data sample may comprise or be otherwise associated with a patient profile comprising member information/data, member features, and/or similar words used herein interchangeably that can be associated with a given member identifier for a patient/individual, claim(s), and/or the like. In some embodiments, a patient profile may include age, gender, known health conditions, home location, medical history, claim history, a member identifier (ID), and/or the like.

The term “classification output” may refer to a data object that describes an output that is generated by processing a classification input using a plurality of classification-based machine learning models. In some embodiments, a classification output may comprise a subset of optimized classification-based machine learning models or a ranked order of the plurality of classification-based machine learning models. In some embodiments, the example classification output may include hyperparameters for each of a plurality of classification-based machine learning models that maximizes each classification-based machine learning model's performance relative to a performance definition set including measures relating to accuracy, precision, and recall.

The term “classification-based machine learning model” may refer to a data object that describes parameters, hyper-parameters, and/or defined operations of a model that is configured to process an input data object in order to generate a predictive output that classifies the input data object into a predefined category. In some embodiments, the classification-based machine learning model may be a supervised or unsupervised machine learning model (e.g., neural network model or clustering model) that is configured to be trained using labeled data, where the machine learning model is configured to generate a medical diagnosis with respect to an input data object describing a patient's medical records/documents (e.g., a medical chart). The output of the classification-based machine learning models may in turn be used to perform one or more prediction-based actions. In various embodiments, a classification-based machine learning model may comprise one or more machine learning models and/or sub-models. For example, an exemplary classification-based machine learning model may comprise a word embedding models, a language model, a term frequency-inverse document frequency (TDIDF)-based model, a natural language processing model, a convolutional neural network variation model, a Transformer-based model (e.g., transformer with sequence classification head, a Deep Learning model (e.g., eXtrme Gradiant Boosting (XGBoost) models, a feed-forward neural network model, an Elastic Net Logistic Regression model, or the like). In some embodiments, a classification-based machine learning model may comprise an ensemble model or stack combining a plurality of machine learning models and/or sub-models. In some embodiments, a classification-based machine learning model may be trained using at least one training data partition that includes a distribution of training data and labels, validation data and labels, and test data and labels. In some embodiments, inputs to a classification-based machine learning model comprise a feature vector for a prediction input and outputs of a classification-based machine learning model comprise a vector describing classification scores for a prediction input.

The term “target performance threshold” may refer to a data object that describes a measure or value describing an inferred determination relating to performance of a classification-based machine learning models. For example, a target performance threshold may be a value (e.g., a percentage value or a number between 0 and 1), where an above-threshold value indicates that a classification-based machine learning model will perform optimally with respect to a particular classification task and/or in accordance with a performance definition set.

The term “rule-based framework” may refer to a data object that describes a set of rules that may be applied to clean/process a dataset or data entities. Examples of rules that may be part of a rule-based framework may include: (i) selectively removing punctuation (e.g., removing semicolons but not slashes in medical documents), (ii) removing repeated characters (e.g., an above-threshold number of character occurrences, such as 3 or more occurrences), (iii) converting all text to lowercase, (iv) removing words longer than 40 characters, and (v) de-identifying information such as zip codes, phone numbers, dates, Uniform Resource Locators (URLs), email addresses, states, cities, and proper nouns/names.

The term “performance definition set” may refer to a data object that describes one or more target measures or values that may be used to assess performance of a machine learning model (e.g., a classification-based machine learning model). In some embodiments, a performance definition set may comprise a relative cost of precision and recall for each of a plurality of categories, such as, accuracy, micro-average precision, macro-average precision, highest recall at X precision, and highest precision at Y recall, or the like. In some embodiments, a performance definition set for a classification-based machine learning model may include relative values of precision and recall. When evaluating model performance, the measures of precision (the fraction of identified items that were identified correctly) and recall (the fraction of items intended to be identified that were identified) are not necessarily equal. The relative values of precision and recall are ultimately determined by the user's objectives and are necessary inputs to determine the relative performance of different models. In other words, the relative values of precision and recall may be determined based at least in part on at least one intended function of a given classification-based machine learning model. By way of example, a classification-based machine learning model that is configured to process a patient's medical images in order to generate a diagnosis (e.g., cancer) may prioritize recall over precision by utilizing the highest precision at a given (e.g., maximum) recall. Conversely, a classification-based machine learning model that is configured to process emails (where false negatives are less critical) in order to identify spam may prioritize precision over recall by utilizing the highest recall at a given (e.g., maximum) precision.

The term “training data partition” may refer to a data object that describes a data chunk (e.g., slice, piece, or unit) that includes a distribution of training data and labels, validation data and labels, and test data and labels that can be used to train a machine learning model (e.g., a classification-based machine learning model). In some embodiments, the performance of a classification-based machine learning model may be assessed based at least in part on a portion of the training data partition that is used as validation data.

In some embodiments, a plurality of classification-based machine learning models may be trained based at least in part on N training data partitions where: (i) training one or more classification-based machine learning models comprises partitioning a group of training samples into the N training data partitions and loading each training data partition on a memory storage medium as a unit, (ii) each training data partition is generated based at least in part on a partitioned subset of the group of training samples that is generated in a manner that is configured to ensure that the partitioned subset comprises a uniform distribution of a plurality of partitioned training samples across a plurality of classes associated with the plurality of classification-based machine learning models, and (iii) N is determined based at least in part on a minimal number of allowed partitions for the plurality of classification-based machine learning models, a maximal number of allowed partitions for the plurality of classification-based machine learning models, and a maximum allowed number of training samples in a particular training data partition. In one example, the number of training data partitions for training a plurality of classification-based machine learning models (i.e., N training data partitions) is determined using the following equation:

$$N = max ( L , M * \frac{S}{1 * 1 {0}^{9}} )$$

In the above equation:
N is the number of training data partitions;
L is the minimum number of allowed partitions;
M is the maximum sequence length;
P is the maximum number of allowed partitions; and
S is the number of samples.

By way of example, using the above equation, if L is 4, M is 40,000, S is 100,000, and P is 1 billion, then N is 4. In another example, if L is 4, M is 40,000, S is 200,000, and P is 1 billion, then N is 8. In yet another example, if L is 4, M is 40,000, S is 1,000,000, and P is 1 billion, then N is 40. For example, in some embodiments, given a classification task that is associated with L classification labels, each training data partition comprises Straining entries, where a given training data partition comprises L sub-partitions, and where each sub-partition comprises at most S/L training entries whose ground-truth class/label is associated with a corresponding classification label for the sub-partition. As an exemplary embodiment, given three classification labels corresponding to “high,” “medium,” and “low” labels respectively, and given a training data partition that comprises 21 training entries, then the training data partition may comprise 7 entries that are associated with a “high” ground-truth label, 7 entries that are associated with a “medium” ground-truth label, and 7 entries that are associated with a “low” ground-truth label.

### III. COMPUTER PROGRAM PRODUCTS, METHODS, AND COMPUTING ENTITIES

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatuses, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. EXEMPLARY SYSTEM ARCHITECTURE

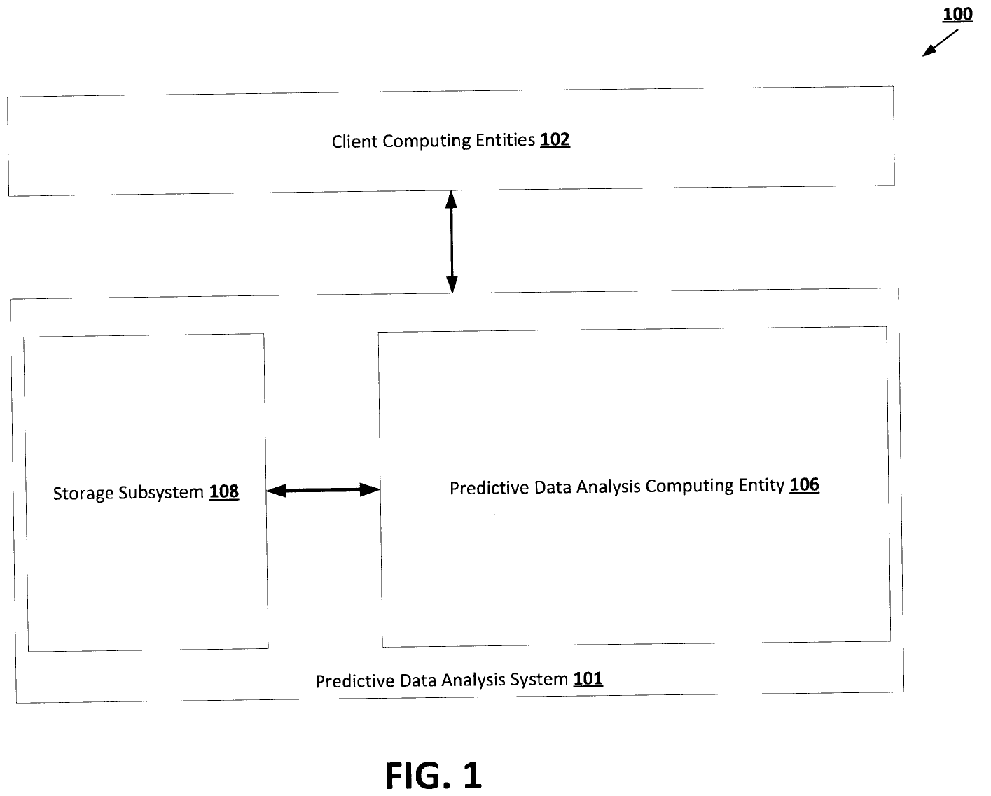

FIG. 1 is a schematic diagram of an example system architecture 100 for performing predictive data analysis operations. The architecture 100 includes a predictive data analysis system 101 configured to receive requests (e.g., a classification input) from client computing entities 102, process the requests to generate predictive outputs (e.g., a classification output) and provide the outputs to the client computing entities 102 (e.g., for providing and/or updating a user interface data). In some embodiments, the predictive data analysis system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 101 may include a predictive data analysis computing entity 106 and a storage subsystem 108. The storage subsystem 108 may be configured to store at least a portion of data utilized by the predictive data analysis computing entity 106 to perform predictive data analysis operations and tasks. The storage subsystem 108 may further be configured to store at least a portion of operational data, including operational instructions and parameters utilized by the predictive data analysis computing entity 106 to perform predictive data analysis operations/tasks in response to requests.

The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Predictive Data Analysis Computing Entity

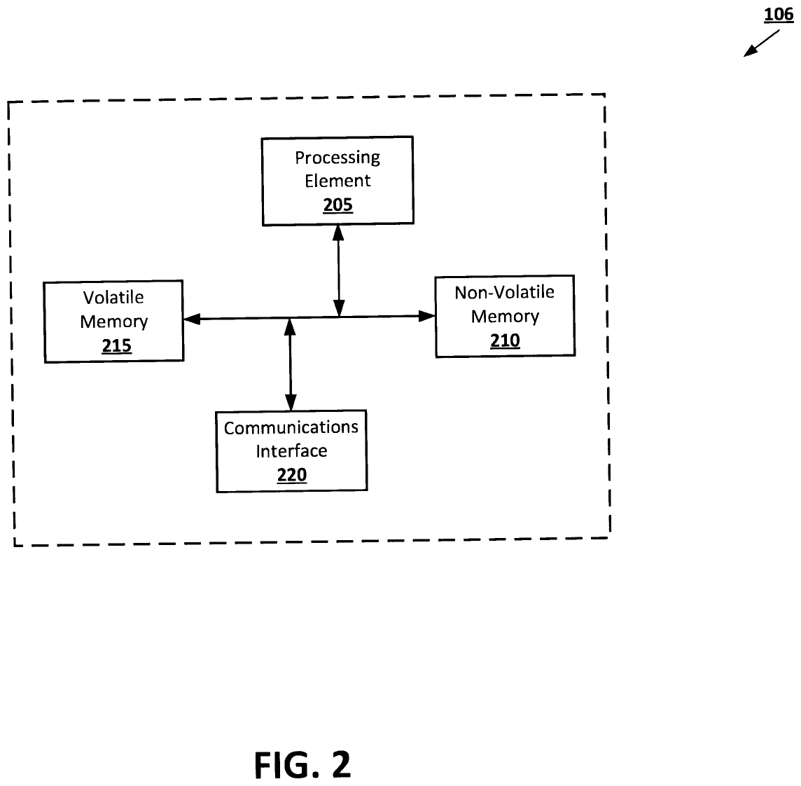

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also include one or more network interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include or be in communication with one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, predictive data analysis systems, data, applications, programs, program modules, scripts, source code, object code, byte code, compiled code, interpreted code, machine code, executable instructions, and/or the like. The term database, database instance, predictive data analysis system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 106 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, predictive data analysis systems, data, applications, programs, program modules, scripts, source code, object code, byte code, compiled code, interpreted code, machine code, executable instructions, and/or the like being executed by, for example, the processing element 205. Thus, the databases, database instances, predictive data analysis systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more network interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless client communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include or be in communication with one or more input elements, such as a keyboard input, a mouse input, a touch screen/display input, motion input, movement input, audio input, pointing device input, joystick input, keypad input, and/or the like. The predictive data analysis computing entity 106 may also include or be in communication with one or more output elements (not shown), such as audio output, video output, screen/display output, motion output, movement output, and/or the like.

### V. EXEMPLARY SYSTEM OPERATIONS

As described below, various embodiments of the present invention improve the speed of training classification-based machine learning models by introducing techniques that enable efficient parallelization of such training routines while enhancing the accuracy of each parallel implementation of a training routine. For example, in some embodiments, a classification-based machine learning model is trained via executing N parallel processes each executing a portion of a training routine, where each parallel process is performed using a training set having a uniform distribution of labels associated with the classification-based machine learning model. In this way, each parallel process is more likely to update parameters of the classification-based machine learning model in accordance with a holistic representation of the training data, which in turn improves the overall accuracy of the resulting trained classification-based machine learning model while enabling parallel training of the classification-based machine learning model. Accordingly, various embodiments of the present invention make important technical contributions via improving the speed of training classification-based machine learning models and by introducing techniques that enable efficient parallelization of such training routines while enhancing the accuracy of each parallel implementation of a training routine.

Described herein are various techniques for predictive data analysis operations that include generating and training a plurality of classification-based machine learning models. Various embodiments of the present invention disclose an end-to-end model comparison system that is configured to receive un-curated, labeled input data, as well as a performance definition set (for example, the highest precision at a given recall or the highest recall at a given precision). With no further user involvement or input, the system can deliver a list of models that are rank ordered according to the performance definition set and in which each of the models has hyperparameters that are optimized to meet the performance definition set given time and memory constraints.

Accordingly, by utilizing some or all of the innovative techniques disclosed herein for performing predictive data analysis, various embodiments of the present invention increase efficiency and accuracy of data storage operations, data retrieval operations, and/or query processing operations across various data storage systems, such as various data storage systems that are part of client-server data storage architectures. In doing so, various embodiments of the present invention make substantial technical contributions to the field of database systems and substantially improve state-of-the-art data storage systems.

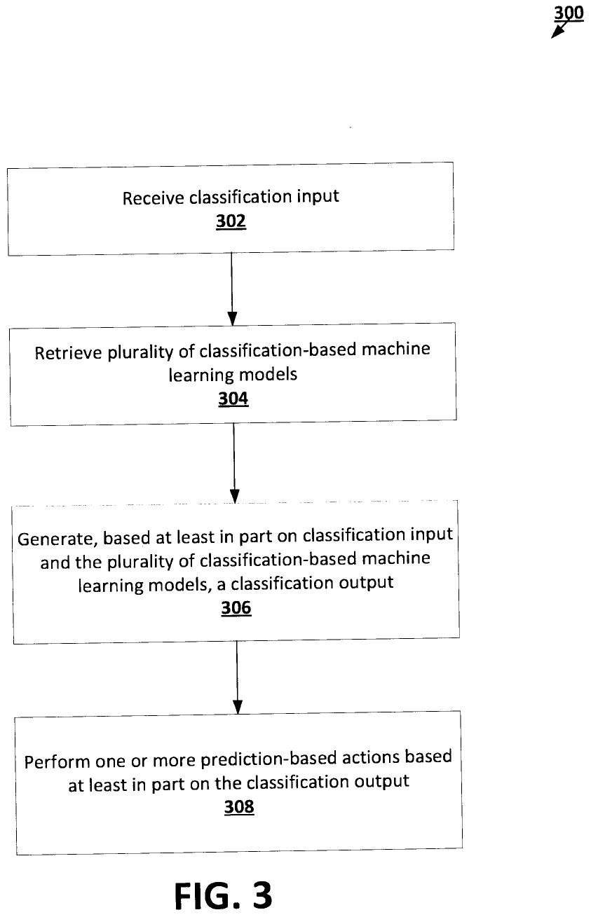

Referring now to FIG. 3, a flowchart diagram illustrating an example process 300 for performing predictive data analysis operations using a predictive data analysis computing entity 106 in accordance with some embodiments discussed herein is provided. Using the steps/operations of the example process 300, a predictive data analysis computing entity 106 can generate a classification output which in turn can be used for performing prediction-based actions. Although, the following exemplary operations are described as being performed by the predictive data analysis computing entity 106, the client computing entity 102 may be configured to perform the steps/operations. For example, the predictive data analysis computing entity 106 or the client computing entity 102 may be the primary computing entity. In some embodiments, a portion of the steps/operations may be performed by the predictive data analysis computing entity 106 and a portion of the operations may be performed by the client computing entity 102.

The process 300 depicted in FIG. 3 begins at step/operation 302 when the predictive data analysis computing entity 106 receives a classification input. The classification input may be a data object that describes input data/information that can be used to generate and/or train one or more classification-based machine learning models. In various embodiments, a classification input may be or comprise structured or unstructured data, un-curated data, labeled data, a performance definition set, a classification type (e.g., multi-class, multi-label, binary), medical data/information (e.g., medical image data) and/or the like.

Subsequent to step/operation 302, the process 300 proceeds to step/operation 304. At step/operation 304, the predictive data analysis computing entity 106 retrieves a plurality of classification-based machine learning models. Each classification-based machine learning model may be a data object that describes parameters, hyper-parameters, and/or defined operations of a model that is configured to process input data objects in order to generate a predictive output that classifies each input data object into a predefined category. In some embodiments, the classification-based machine learning model may be a supervised or unsupervised machine learning model (e.g., neural network model or clustering model) that is configured to be trained using labeled data in order to generate a medical diagnosis with respect to an input data object describing a patient's medical records/documents (e.g., medical chart). The output of a classification-based machine learning model may in turn be used to perform one or more prediction-based actions. An exemplary classification-based machine learning model may comprise a word embedding models, a language model, a term frequency-inverse document frequency (TDIDF)-based model, a natural language processing model, a convolutional neural network variation model, a Transformer-based model (e.g., transformer with sequence classification head, a Deep Learning model (e.g., eXtrme Gradiant Boosting (XGBoost) models, a feed-forward neural network model, an Elastic Net Logistic Regression model, or the like, an ensemble model/stack combining a plurality of machine learning models and/or sub-models, and/or the like. In some embodiments, a classification-based machine learning model may be trained using at least one training data partition that includes a distribution of training data and labels, validation data and labels, and test data and labels.

Subsequent to step/operation 304, the example process 300 proceeds to step/operation 306. At step/operation 306, the predictive data analysis computing entity 106 generates, based at least in part on the classification input and the plurality of classification-based machine learning models, a classification output. The example classification output may comprise a data object that describes an output generated by processing a classification input using a plurality of classification-based machine learning models. In some embodiments, a classification output may be a subset of a plurality of classification-based machine learning models that are determined to be optimal for performing at least one classification-based task or process (e.g., generate predictive outputs). In some examples, the classification output may be a ranked order of a plurality of classification-based machine learning models. In some embodiments, the classification output may be a subset of the plurality of classification-based machine learning models that satisfy a target performance threshold. The target performance threshold may be a value (e.g., a percentage value or a number between 0 and 1), where an above-threshold value indicates that a classification-based machine learning model will perform optimally with respect to a particular classification task and/or in accordance with a performance definition set.

In some embodiments, the example classification output may include hyperparameters for each of a plurality of classification-based machine learning models that maximizes each classification-based machine learning model's performance relative to a performance definition set such as accuracy, precision, and recall.

Subsequent to step/operation 306, the process 300 proceeds to step/operation 308. At step/operation 308, the predictive data analysis computing entity 106 performs one or more prediction-based actions based at least in part on the classification output, as discussed in more detail below.

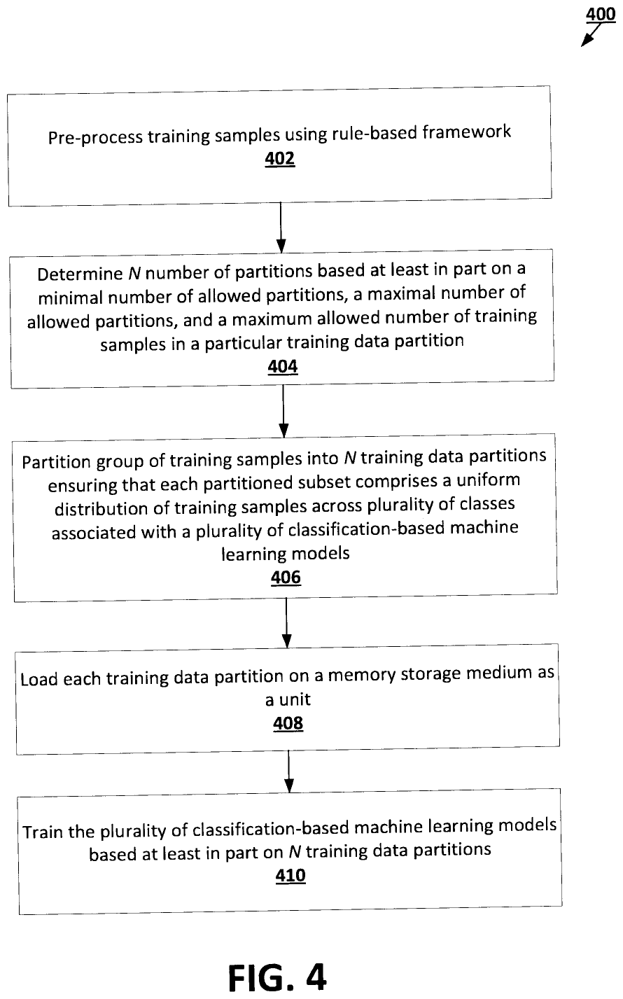

Referring now to FIG. 4, a flowchart diagram illustrating an example process 400 for training a plurality of classification-based machine learning models by a predictive data analysis computing entity 106 in accordance with some embodiments discussed herein is provided.

Beginning at step/operation 402, the predictive data analysis computing entity 106 pre-processes training samples using a rule-based framework (e.g., a set of predefined rules that are associated with a particular context). In various examples, the predictive data analysis computing entity 106 is configured to process (e.g., clean, standardize, and/or order uniformly) different data types and formats to facilitate uniform processing operations. By way of example, the predictive data analysis computing entity 106 may convert data (e.g., image data and/or text) associated with an individual (e.g., patient) into a single text file that is ordered chronologically and associated with a unique identifier (e.g., patient identifier, member identifier, or the like). In some embodiments, the predictive data analysis computing entity 106 can accept an input dataset broken into parquet partitions or represented in a single parquet file. In some embodiments, the predictive data analysis computing entity 106 may split the data across cores on a machine to clean chunks of the data in parallel. Subsequent to performing data cleaning operations, the predictive data analysis computing entity 106 may recombine the data and provide (e.g., transmit, send) a copy to multiple machines (e.g., central processing units (CPUs) or Graphics Processing Units (GPUs)). In some embodiments, the predictive data analysis computing entity 106 may utilize a rule-based framework comprising one or more rules to clean chunks of data. Exemplary rules may include: (i) strip particular characters from the start and end of all words (e.g., “.!″#$&′( )*+,/:;?@[\\]\hat{ }_′{|}˜”.); (ii) remove certain characters in their entirety that are not relevant in a particular context (e.g., “!″#$&′( )*+,;?@[\\]\hat{ }_′{|}˜”.; (iii) eliminate long words (e.g., 39 or more characters); (iv) eliminate characters occurring with a certain frequency (e.g., three times in a row within a word); (v) eliminate identifying information (e.g., dates, phone numbers, URLs, states, names, cities, and emails); and (vi) leave numbers as they are (do not bucket). In general, certain characters that are relevant in a particular context may be retained or excluded. For example, in a medical context, “/” may be retained, and numbers on the range of −500 to 500 may be excluded.

Subsequent to step/operation 402, the process 400 proceeds to step/operation 404. At step/operation 404, the predictive data analysis computing entity 106 determines N number of training data partitions based at least in part on a minimal number of allowed partitions, a maximal number of allowed partitions, and a maximum allowed number of training samples in a particular training data partition. In some embodiments, the minimal number of allowed partitions and the maximum allowed number of training samples may each be user configurable parameters that are selected based at least in part on a total number of available training samples. In some embodiments, the maximal number of allowed partitions may correspond with a number of available cores on one or more processors or machines. By way of example, if the number of available cores on one or more processors or machines is 32 cores, the predictive data analysis computing entity 106 may determine that 32 datasets are required. In some embodiments, the predictive data analysis computing entity 106 may determine N number of training data partitions using the following equation:

$$N = max ( L , M * \frac{S}{1 * 1 {0}^{9}} )$$

In the above equation:
N is the number of training data partitions;
L is the minimum number of allowed partitions;
M is the maximum sequence length;
P is the maximum number of allowed partitions; and
S is the number of samples.

By way of example, using the above equation, if L is 4, M is 40,000, S is 100,000, and P is 1 billion, then N is 4. In another example, if L is 4, M is 40,000, S is 200,000, and P is 1 billion, then N is 8. In yet another example, if L is 4, M is 40,000, S is 1,000,000, and P is 1 billion, then N is 40.

In various embodiments, N number of training data partitions is an optimal number of data chunks that is dependent on the amount of data and the capability of the available/selected hardware being utilized by predictive data analysis computing entity 106. In various examples, the optimal number of data chunks is selected to optimize memory use. Additionally, an algorithm may be used to ensure that the distribution of labels is consistent across the data chunks, and predictive data analysis computing entity 106 may process the training samples to reduce the dimensionality of the data. In some embodiments, the predictive data analysis computing entity 106 may scale the number of data partitions according to the number of data folds used for k-fold cross-validation to select model hyperparameters. This allows training on more data than will fit in memory while limiting the number of read operations executed while training each classification-based machine learning model. In various embodiments, the predictive data analysis computing entity 106 uses an algorithm that scales the number of data partitions as the number of samples and/or the sequence length(s) increase. In order to limit memory requirements, instead of setting the number of partitions to be equal to the total number of data samples (which may require reading data for each sample), using the above-noted algorithm, the predictive data analysis computing entity 106 can balance the number of read operations with the number of samples that can fit into memory by only increasing the number of partitions as the total number of samples and/or sequence length increases.

Subsequent to step/operation 404, the process 400 proceeds to step/operation 406. At step/operation 406, the predictive data analysis computing entity 106 partitions a group of training samples into N training data partitions ensuring that each partitioned subset comprises a uniform distribution of training samples across a plurality of classes associated with the plurality of classification-based machine learning models. In some embodiments, the predictive data analysis computing entity 106 uses iterative stratified splitting for both k-fold cross-validation and the train, validation, and test splits to maintain a similar prevalence of each class across each data split and decides the size of each split according to relative size parameters provided (e.g., selected) by a user, (e.g., 70% training, 12% validation, 18% test with 5-fold cross-validation). In some embodiments, labels are balanced across data splits using iterative stratified splitting, and the data partitions are also created such that the prevalence of labels across splits is roughly uniform by applying the iterative stratified splitting algorithm when creating data partitions. In contrast with known techniques which may only apply an algorithm to folds in k-fold cross validation and train/validation/test splits, the present disclosure provides techniques that utilize iterative stratified splitting to achieve a uniform distribution of labels across the data partitions. The process of chunking data for memory efficiency/partitioning provides more accurate estimates of the gradient for each partition of data when loaded into memory, because the data partitions will contain samples belonging to each data class, e.g., the targets for a multi-class or multi-label prediction problem. Additionally, stable and consistent weight updates and smooth convergence when computing classification-based machine learning models gradients can be ensured by loading one data partition at a time during training.

While various embodiments of the present invention require that each training data partition includes a uniform distribution of training entries across classification labels, a person of ordinary skill in the relevant technology will recognize that a training data partition may comprise another distribution of training entries across classification labels. For example, in some embodiments, the training configuration data may require that w₁ percent of training data partitions have a uniform distribution of training entries across classification labels, w₂ percent of training data entries have a normal distribution of training entries across classification labels, and w₃ percent of training data entries be randomly selected without imposing any distribution with respect to classification labels. In some of the noted embodiments, w₁, w₂, and w₃ are tuned or trained hyper-parameters of the classification-based machine learning model. In some embodiments, given a training data set that comprises P training data partitions, each training data partition is preprocessed using a distinct dropout mechanism of P distinct dropout mechanisms. For example, given P=3 training data partitions, the three data partitions may include: a first training data partition comprising w₁ percent of training data partitions that have a uniform distribution of training entries across classification labels and whose training data entries are preprocessed in accordance with a dropout mechanism for uniform distribution training data, a second training data partition comprising w₂ percent of training data partitions that have a normal distribution of training entries across classification labels and whose training data entries are preprocessed in accordance with a dropout mechanism for normal distribution training data, and a third training data partition comprising w₃ percent of training data entries that are randomly selected without imposing any distribution with respect to classification labels and are not subject to any dropout mechanisms.

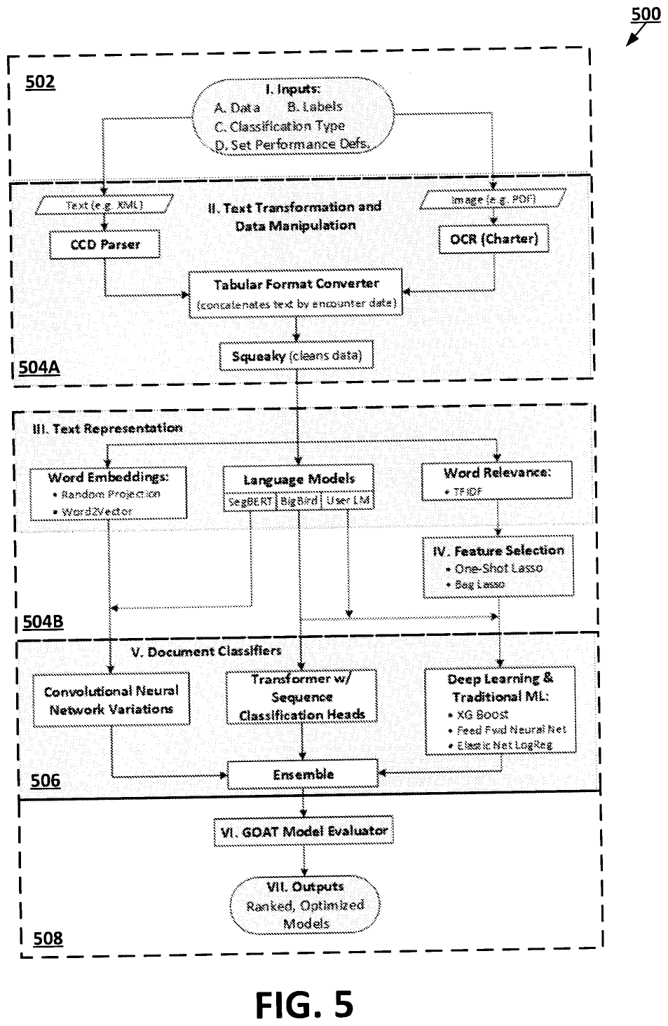

Subsequent to step/operation 406, the process 400 proceeds to step/operation 408. At step/operation 408, the predictive data analysis computing entity 106 loads each training data partition on a memory storage medium as a unit. In various embodiments, and as discussed in connection with FIG. 5 below, the predictive data analysis computing entity 106 creates multiple feature sets using different text representations. Text representations may include, but are not limited to, (i) a term frequency inverse document frequency (TDIDF) representation of N grams, (ii) a Word2vec representation of word-level features, and (iii) long-document language model representations of entire input sequences tokenized at the sub-word level to avoid the fixed vocabulary problem. It should be understood that different representations may perform better for classification-based tasks depending on complexity, volume of input data, number of labels, and length of input sequences.

Subsequent to step/operation 408, the process 400 proceeds to step/operation 410. At step/operation 410, the predictive data analysis computing entity 106 trains the plurality of classification-based machine learning models based at least in part on N training data partitions. In some embodiments, when a data partition is loaded into memory, the data partition is used to estimate a gradient of the loss function for batches of each partition. Each time the gradient is estimated, the weights of the machine learning model are updated according to the direction of the gradient and the learning rate. In this manner, the machine learning model is trained and updates its parameters as each data partition is loaded. In some embodiments, a plurality of machine learning models can be trained simultaneously on a plurality of different machines where each machine uses the above-noted data loading technique.

In some embodiments, the predictive data analysis computing entity 106 processes the training data samples to generate a plurality of text representations. For example, the predictive data analysis computing entity 106 may vectorize each training data sample to convert text into an input-vector based representation of an input document, such as a numerical representation in a multi-dimensional (e.g., an N-dimensional) embedding space corresponding with a particular training data sample. In some embodiments, the predictive data analysis computing entity 106 may utilize a plurality of different approaches (e.g., at least 3 different vectorization techniques) for translating raw text strings (e.g., a medical document) into vectors to determine which adds the most predictive value to the classification-based machine learning models that it trains. For example, the predictive data analysis computing entity 106 may process standardized, chunked text using language-based models, word embedding techniques, and term frequency inverse document frequency (TFIDF) representations. In some embodiments, the predictive data analysis computing entity 106 may process training data samples using multiple approaches in parallel. In some embodiments, the predictive data analysis computing entity 106 may utilize a single technique based at least in part on the available amount of data. Each text representation approach/vectorization technique may be different in terms of interpretability, time to generate, and downstream classification-based machine learning model performance. In some embodiments, the predictive data analysis computing entity 106 may provide or generate information relating to predictive phrases in the text in addition to selecting or identifying the best performing classification-based machine learning model(s).

Referring now to FIG. 5, a schematic diagram depicting an example framework/architecture 500 for training a plurality of classification-based machine learning models by a predictive data analysis computing entity 106 is provided.

As depicted in FIG. 5, and as discussed above, at step/operation 502, the predictive data analysis computing entity 106 receives and processes a classification input comprising data (e.g., training data samples), labels, a classification type, a performance definition set, and/or the like.

As further depicted in FIG. 5, the predictive data analysis computing entity 106 pre-processes training data samples at step/operation 504A. In some embodiments, as shown, predictive data analysis computing entity 106 processes a classification input using a Continuity of Care Document (CCD) parser in order to generate text files. In some examples, the predictive data analysis computing entity 106 removes text from fields and stores the text as a continuous text string. In some embodiments, and in a medical context, the predictive data analysis computing entity 106 uses the CCD parser to identify dates associated with patient encounters (e.g., provider visits). In some embodiments, the predictive data analysis computing entity 106 may apply optical character recognition (OCR) processing to data containing images of text (such as those in portable document format (PDF) files) in order to identify text characters in image data. Predictive data analysis computing entity 106 may handle multiple OCR asynchronously thereby increasing processing efficiency (e.g., eliminating idle time spent waiting for files to arrive and undergo processing). In some embodiments, the predictive data analysis computing entity 106 may use the outputs from the CCD parser and OCR processing as inputs to a Tabular Format Converter (TBC) which may be used to concatenate data (e.g., patient data) chronologically. In relation to patient data, the predictive data analysis computing entity 106 may use the TBC may to generate a data frame of identifiers and text and a data frame of identifiers and labels. By way of example, for a given patient with multiple documents, encounters may be concatenated in order of occurrence to create a single document with a single identifier. Additionally, the predictive data analysis computing entity 106 may use the TBC to generate labels representing attributes of the text for the single, combined document.

In some embodiments, the predictive data analysis computing entity 106 processes the training data samples (e.g., TBC outputs) using a rule-based framework comprising rules such as: (i) selectively remove punctuation (e.g., removing semicolons but not slashes in medical documents), (ii) remove repeated characters (e.g., an above-threshold number of character occurrences, such as 3 or more occurrences), (iii) converting all text to lowercase, (iv) remove words longer than 40 characters, and (v) de-identifying information such as zip codes, phone numbers, dates, Uniform Resource Locators (URLs), email addresses, states, cities, and proper nouns/names. Predictive data analysis computing entity 106 may clean small data subsets in each of the above-detailed processes and combine the outputs to generate a large, clean dataset.

As illustrated in FIG. 5, at step/operation 504B, the predictive data analysis computing entity 106 generates a plurality of text representations. For example, the predictive data analysis computing entity 106 may vectorize training data samples using language models/multi-word representations in order to capture the meaning of the underlying text in their context. In some examples, the predictive data analysis computing entity 106 may comprise one or more sub-models (e.g., a Reformer model and Transformer-based models, such as but not limited to, a Segmented Bidirectional Encoder Representations from Transformers (SEG-BERT) model, a BigBird model, and/or the like) that are each configured to process large amounts of text (e.g., 10,000 words). By way of example, the predictive data analysis computing entity 106 may be configured to represent long medical documents in a context-sensitive way, and in a time and memory efficient manner using the above-noted sub-models (e.g., language models). By way of example, the word “bank” may be given different representations in “river bank” and “blood bank.” An example language model may vectorize text in ways that account for such contextual differences. In some embodiments, in contrast with conventional systems which rely on generic data samples, the predictive data analysis computing entity 106 may pretrain the sub-models/language models using medical documents in order to ensure that the trained classification-based machine learning models are more accurate in a medical context. In some embodiments, the predictive data analysis computing entity 106 may use a custom user-selected language model instead of or in addition to the sub-models/language models described above. In various examples, the predictive data analysis computing entity 106 may generate a plurality of vectors that each represent multiple words.

As depicted in FIG. 5, In some embodiments, the predictive data analysis computing entity 106 processes training data samples using word embedding models/techniques. For example, the predictive data analysis computing entity 106 may process training data samples to generate single-word vector representations for each word as an alternative to the language-based approach detailed above. Example embedding models may include Random Projection and Word2vec sub-models. In some embodiments, Random Projection and Word2vec models may serve as alternatives depending on the amount of available data. Certain configurations may execute both Random Projection and Word2vec in parallel while others may specify only one model as a function of the amount of data.

As depicted in FIG. 5, In some embodiments, the predictive data analysis computing entity 106 processes training data samples using a TFIDF-based model to generate interpretable n-gram features (short phrases) where a relative frequency of each phrase is associated with weights that represent the predictive impact of the phrase. The relative frequency of phrases may relate to why a particular document is labeled in a particular way. For example, a frequency of a word within a document may be divided by the word's overall frequency within a larger corpus (that may include the document). Accordingly, TFIDF is a measure indicating how important a word is in describing the subject of a document in which it appears. Additionally, and/or alternatively, in some embodiments, the predictive data analysis computing entity 106 applies dimensionality reduction and/or feature selection (in sequence or as alternatives) to a TFIDF-based model in order to improve interpretability and overall performance. In some examples, the predictive data analysis computing entity 106 uses a one-shot least absolute shrinkage and selection operator (LASSO) sub-model or a bag LASSO sub-model to select optimal features for TDIDF. The output from the one-shot and/or bag LASSO sub-models may be a vector with fewer dimensions than TDIDF. By way of example, a one-shot LASSO model may perform better than a bag LASSO model when there is less available data. However, a bag LASSO model may be more accurate and consider more features in order to provider better estimates of predictive phrases.

As further illustrated in FIG. 5, subsequent to generating a plurality of text representations at step/operation 504B, at step/operation 506, the predictive data analysis computing entity 106 trains a plurality of classification-based machine learning models in parallel. In some examples, the parallel training process may be spread amongst multiple CPUs or GPUs. For example, each of a plurality of classification-based machine learning models may be trained on a separate GPU. In some embodiments, the training process may comprise running Bayesian optimization to find the best hyperparameters for each model architecture on a different machine simultaneously. Said differently, the predictive data analysis computing entity 106 may begin the process on a single machine, continue processing on a plurality of machines (e.g., GPUs), and generate a final output for presentation on the single machine. In some embodiments, the predictive data analysis computing entity 106 may use classification-based machine learning models that are proven to work well in the medical context. The predictive data analysis computing entity 106 may select parameters and hyper-parameters for each classification-based machine learning model that most accurately predict the test data and use the best performing version of each classification-based machine learning model.

In the example shown in FIG. 5, the predictive data analysis computing entity 106 uses a Transformer with sequence classification head, Convolutional Neural Network (CNN) variation-based models, and Deep Learning and traditional machine learning classifiers (e.g., eXtrme Gradiant Boosting (XGBoost) models, a feed-forward neural network (FFNN) model, and an Elastic Net Logistic Regression model). As further depicted, predictive data analysis computing entity 106 may use an ensemble machine-learning model that is configured to determine whether a particular combination of trained machine-learning models performs better than individual model, and if so, the optimal weights of the combination. Each classification-based machine learning model may be used to generate predictive outputs for test data using optimized parameters and hyper-parameters. In some embodiments, as noted herein, the predictive data analysis computing entity 106 trains a plurality of machine learning models using different machines (e.g., each machine learning model is trained on a separate machine) and determines the optimal weights for each model depending on the type of model being trained.

In some embodiments, the predictive data analysis computing entity 106 may use a CNN variation-based model to analyze windows of text and assess interactions between different windows. CNN variation-based models can be used to process either single or multi-word language models. In some embodiments, Deep Learning and traditional machine learning classifiers may be most suitable for processing TDIDF outputs. In some embodiments, XGBoost models may be used to model interactions between phrases and their TFIDF values. In some embodiments, FFNN models may be used to model interactions between phrases and their TDIDF values, providing greater complexity in comparison to XGBoost models. In some embodiments, an Elastic Net Logistic Regression model may use logistic regression techniques to model linear relationships between phrases and their TDIDF measures/values.

In one example, the predictive data analysis computing entity 106 creates two feature sets and builds the final Elastic Net Logistic Regression model, feed-forward neural network, and XGBoost models (3 models) twice (for a total of 6 models of this kind), once with each feature set. Predictive data analysis computing entity 106 may create a first feature set by fitting a LASSO regression model with grid search for the penalization term, selecting the best penalization term, then fitting another LASSO model with that term. The features with coefficients >0 in absolute value may be retained, and the others eliminated to create the first feature set. Predictive data analysis computing entity 106 may create a second feature set by performing this procedure N times using D samples from a dataset with replacement. Then, the predictive data analysis computing entity 106 may use the features with coefficients >0 in absolute value for M of the N iterations. In another example, the predictive data analysis computing entity 106 may use a long document language model pretrained on millions of medical charts and represent sequences of text as combinations of 32,000 byte-pair-encoding tokenized sub-words learned from the input data and truncated to a maximum of 32,768 sub-words. Pretrained classification-based machine learning models may provide an intelligent initialization, tailored to long medical documents, for the representation of input documents run to build new document classifiers.

In some embodiments, as shown in FIG. 5, the Transformer with sequence classification head may use the outputs of the language models/multi-word representations as inputs; the CNN variations may use the outputs from the word embedding models as inputs; and the Deep Learning and traditional machine learning classifiers may use the outputs from the TDIDF and feature selection sub-models (e.g., one-shot and/or bag LASSO sub-models). In some examples, the predictive data analysis computing entity 106 may determine optimal weights or weighted averages for each of the plurality of classification-based machine learning models and/or identify one or more classification-based machine learning models that generate optimal predictive outputs based at least in part on the test data.

In some embodiments, at step/operation 508, the predictive data analysis computing entity 106 may output a greatest of all time (GOAT) model evaluator that is configured to generate performance metrics for each classification-based machine learning model and rank each of the models according to user-defined set performance definitions. The inputs to the GOAT model evaluator may be the outputs of the classifiers/ensemble model described above in addition to the performance definition set. In some embodiments, an output of the GOAT evaluator may be a rank order of each of a plurality of classification-based machine learning models according to the performance definition set (e.g., relative costs of false positives versus false negatives). In some embodiments, the predictive data analysis computing entity 106 may output hyperparameters for each model type that maximize the model's performance relative to the performance definitions set.

In various embodiments, the predictive data analysis computing entity 106 may be configured to respond to requests, prepare/train a plurality of classification-based machine learning models, and/or trigger generation (e.g., by a client computing entity 102) of user interface data (e.g., messages, data objects and/or the like) corresponding with predictive outputs. A client computing entity 102 may provide the user interface data for presentation by a user computing entity. In some embodiments, the user interface data may be or comprise a classification output (e.g., a ranked order of classification-based machine learning models). Predictive data analysis computing entity 106 may be configured to generate one or more Application Programming Interface (API)-based data objects corresponding with at least a portion of the predictive outputs. Predictive data analysis computing entity 106 may provide (e.g., transmit, send) the one or more API-based data objects representing at least a portion of the predictive outputs to an end user interface for display and/or further steps/operations. The predictive outputs may be used to dynamically update the user interface operated by an end user.

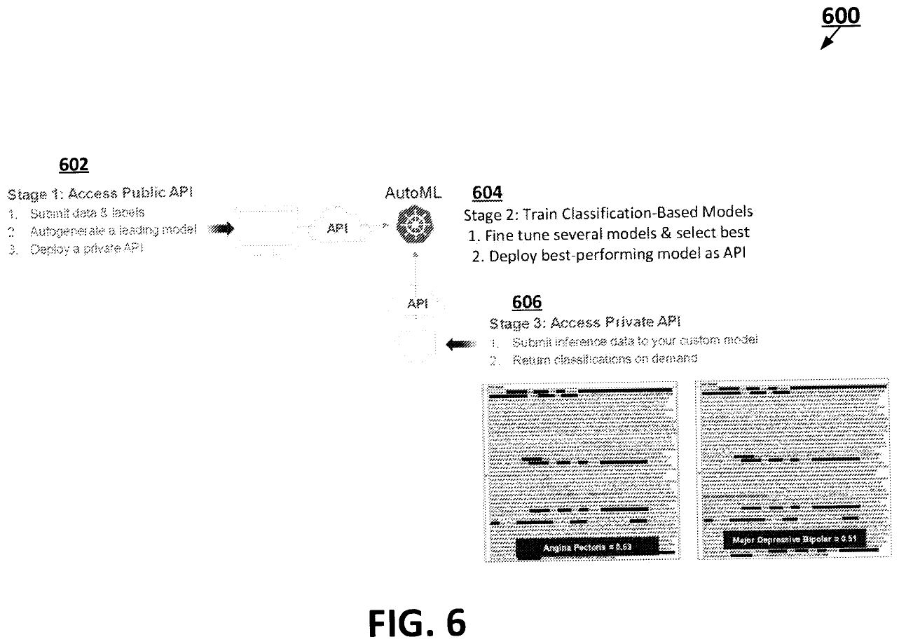

Referring now to FIG. 6, a schematic diagram depicting an operational example 600 of performing one or more prediction-based actions is provided.

As depicted in FIG. 6, at step/operation 602, an end user (via an client computing entity 102) provides data/information by accessing a public API. In some embodiments, an end user may submit data and labels that can be used to automatically generate/select an optimal classification-based machine learning models that will be deployed as a private API.

As further illustrated, at step/operation 604, the predictive data analysis computing entity 106 generates, selects, and/or trains a plurality of classification-based machine learning models using the techniques discussed above. Predictive data analysis computing entity 106 may fine tune a subset of the plurality of classification-based machine learning models and/or select an optimal model for deployment.

Subsequently, at step/operation 606, the client computing entity 102 accesses the private API and submits inference data (e.g., raw data) to the customized classification-based machine learning models for returning classifications on demand/in response to queries.

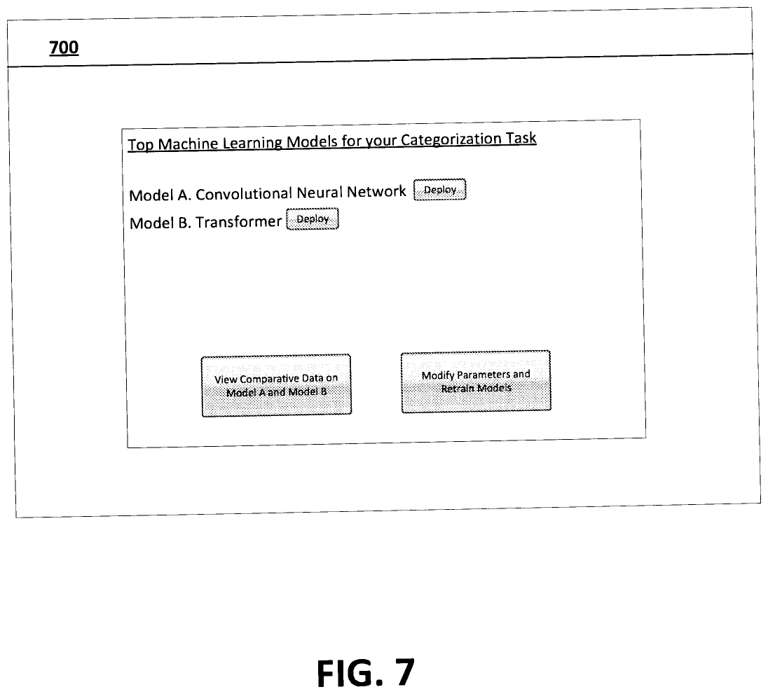

Referring now to FIG. 7, an operational example depicting a prediction output user interface 700 that may be generated based at least in part on user interface data which is in turn generated based at least in part on the above-described predictive outputs. The client computing entity 102 may generate the user interface data and present (e.g., transmitted, sent and/or the like) corresponding user interface data for presentation by the prediction output user interface 700.

As depicted in FIG. 7, the user interface data comprises an ordered ranking of classification-based machine learning models that have been trained by predictive data analysis computing entity 106 which satisfy a performance definition set/a target performance threshold. As depicted, the user interface data depicts various user-selectable interface elements for initiating/implementing various prediction-based actions/tasks. In particular, as shown, a user may engage/select a user-selectable interface element to deploy a particular classification-based machine learning models (“Model A” or “Model B”), view comparative performance data for one or more classification-based machine learning models, and/or provide additional input data/parameters for retraining one or more classification-based machine learning models.

The prediction output user interface 700 may comprise various additional features and functionalities for accessing, and/or viewing user interface data. The prediction output user interface 700 may also comprise messages to an end-user in the form of banners, headers, notifications, and/or the like. As will be recognized, the described elements are provided for illustrative purposes and are not to be construed as limiting the dynamically updatable interface in any way.

Accordingly, as described above, various embodiments of the present invention improve the speed of training classification-based machine learning models by introducing techniques that enable efficient parallelization of such training routines while enhancing the accuracy of each parallel implementation of a training routine. For example, in some embodiments, a classification-based machine learning model is trained via executing N parallel processes each executing a portion of a training routine, where each parallel process is performed using a training set having a uniform distribution of labels associated with the classification-based machine learning model. In this way, each parallel process is more likely to update parameters of the classification-based machine learning model in accordance with a holistic representation of the training data, which in turn improves the overall accuracy of the resulting trained classification-based machine learning model while enabling parallel training of the classification-based machine learning models. Accordingly, various embodiments of the present invention make important technical contributions via improving the speed of training classification-based machine learning models and by introducing techniques that enable efficient parallelization of such training routines while enhancing the accuracy of each parallel implementation of a training routine.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for generating a classification output for a classification input using a plurality of classification-based machine learning models, the computer-implemented method comprising:
generating, by one or more processors, using the plurality of classification-based machine learning models, and based at least in part on the classification input, the classification output, wherein:
(i) the plurality of classification-based machine learning models is trained based at least in part on N training data partitions,
(ii) training the plurality of classification-based machine learning models comprises partitioning a group of training samples into the N training data partitions and loading each training data partition on a memory storage medium as a unit,
(iii) each training data partition is generated based at least in part on a partitioned subset of the group of training samples that is generated in a manner that is configured to ensure that the partitioned subset comprises a uniform distribution of a plurality of partitioned training samples across a plurality of classes associated with the plurality of classification-based machine learning models, and
(iv) N is determined based at least in part on a minimal number of allowed partitions for the plurality of classification-based machine learning models, a maximal number of allowed partitions for the plurality of classification-based machine learning models, and a maximum allowed number of training samples in a particular training data partition; and
performing one or more prediction-based actions based at least in part on the classification output.

2. The computer-implemented method of claim 1, wherein generating the classification output comprises identifying at least one of the classification-based machine learning models that satisfies a target performance threshold.

3. The computer-implemented method of claim 2, wherein the training samples are pre-processed using a rule-based framework.

4. The computer-implemented method of claim 1, wherein each of the plurality of classification-based machine learning models is training using a separate graphics processing unit (GPU).

5. The computer-implemented method of claim 1, wherein each training sample comprises an input-vector based representation of an input document.

6. The computer-implemented method of claim 1, wherein the classification output comprises an ordered sequence of the plurality of classification-based machine learning models according to performance definition set.

7. The computer-implemented method of claim 6, wherein the performance definition set include a relative cost of precision and recall.

8. An apparatus for generating a classification output for a classification input using a plurality of classification-based machine learning models, the apparatus comprising at least one processor and at least one memory including program code, the at least one memory and the program code configured to, with the processor, cause the apparatus to at least:
generate, using the plurality of classification-based machine learning models, and based at least in part on the classification input, the classification output, wherein:
(i) the plurality of classification-based machine learning models is trained based at least in part on N training data partitions,
(ii) training the plurality of classification-based machine learning models comprises partitioning a group of training samples into the N training data partitions and loading each training data partition on a memory storage medium as a unit,
(iii) each training data partition is generated based at least in part on a partitioned subset of the group of training samples that is generated in a manner that is configured to ensure that the partitioned subset comprises a uniform distribution of a plurality of partitioned training samples across a plurality of classes associated with the plurality of classification-based machine learning models, and
(iv) N is determined based at least in part on a minimal number of allowed partitions for the plurality of classification-based machine learning models, a maximal number of allowed partitions for the plurality of classification-based machine learning models, and a maximum allowed number of training samples in a particular training data partition; and
perform one or more prediction-based actions based at least in part on the classification output.

9. The apparatus of claim 8, wherein generating the classification output comprises identifying at least one of the classification-based machine learning models that satisfies a target performance threshold.

10. The apparatus of claim 9, wherein the training samples are pre-processed using a rule-based framework.

11. The apparatus of claim 8, wherein each of the plurality of classification-based machine learning models is training using a separate GPU.

12. The apparatus of claim 8, wherein each training sample comprises an input-vector based representation of an input document.

13. The apparatus of claim 8, wherein the classification output comprises an ordered sequence of the plurality of classification-based machine learning models according to performance definition set.

14. The apparatus of claim 13, wherein the performance definition set include a relative cost of precision and recall.

15. A computer program product for generating a classification output for a classification input using a plurality of classification-based machine learning models, the computer program product comprising at least one non-transitory computer-readable storage medium having computer-readable program code portions stored therein, the computer-readable program code portions configured to:
generate, using the plurality of classification-based machine learning models, and based at least in part on the classification input, the classification output, wherein:
(i) the plurality of classification-based machine learning models is trained based at least in part on N training data partitions,
(ii) training the plurality of classification-based machine learning models comprises partitioning a group of training samples into the N training data partitions and loading each training data partition on a memory storage medium as a unit,
(iii) each training data partition is generated based at least in part on a partitioned subset of the group of training samples that is generated in a manner that is configured to ensure that the partitioned subset comprises a uniform distribution of a plurality of partitioned training samples across a plurality of classes associated with the plurality of classification-based machine learning models, and
(iv) N is determined based at least in part on a minimal number of allowed partitions for the plurality of classification-based machine learning models, a maximal number of allowed partitions for the plurality of classification-based machine learning models, and a maximum allowed number of training samples in a particular training data partition; and
perform one or more prediction-based actions based at least in part on the classification output.

16. The computer program product of claim 15, wherein:
generating the classification output comprises identifying at least one of the classification-based machine learning models that satisfies a target performance threshold.

17. The computer program product of claim 16, wherein the training samples are pre-processed using a rule-based framework.

18. The computer program product of claim 15, wherein each of the plurality of classification-based machine learning models is training using a separate GPU.

19. The computer program product of claim 15, wherein each training sample comprises an input-vector based representation of an input document.

20. The computer program product of claim 15, wherein the classification output comprises an ordered sequence of the plurality of classification-based machine learning models according to performance definition set.
